(19) United States
(12) Patent Application Publication
(10) Pub. No.: US 2026/0254149 A1
(43) Pub. Date: Aug. 27, 2026

(54) STACKED CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Tetsuya MIYAMURA, Mie (JP)

(21) Appl. No.: 18/690,189

(22) PCT Filed: Aug. 25, 2022
(86) PCT No.: PCT/JP2022/031978

§ 371 Date: Mar. 7, 2024

(30) Foreign Application Priority Data
Sep. 15, 2021 (JP) 2021-149877

(51) Int. Cl. H01R 13/514

(52) U.S. Cl. CPC H01R 13/514

(57) ABSTRACT

A stacked connector includes: a first housing that has a flat shape; and a second housing that has a flat shape and is stacked on the first housing, the first housing has a first elastic locking piece that is elastically deformable and extends in a cantilever-like shape in which the two housings are stacked, and a first locking portion that is not elastically deformable, the second housing has a second elastic locking piece that is elastically deformable and extends in a cantilever-like shape in a direction that intersects the stacking direction, and a second locking portion that is not elastically deformable, and the first housing and the second housing are held in a stacked state by the first elastic locking piece and the second locking portion engaging with each other or the second elastic locking piece and the first locking portion engaging with each other.

### TECHNICAL FIELD

The present disclosure relates to a stacked connector.

### BACKGROUND

Patent Document 1 discloses a stacked connector formed by stacking two plate-shaped housings. The two plate-shaped housings are held in a stacked state by engaging an elastically deformable engagement piece formed on one plate-shaped housing with a protruding portion of the other plate-shaped housing.

### PRIOR ART DOCUMENT

### Patent Document

Patent Document 1: JP 2008-084672 A

### SUMMARY OF THE INVENTION

### Problems to be Solved

The engagement piece extends in a cantilever-like shape. To prevent damage to the engagement piece during the elastic deformation thereof, it is necessary to secure a certain extension dimension of the engagement piece. The direction in which the engagement piece extends is the same as the stacking direction of the two plate-shaped housings, and therefore, it is difficult to downsize the stacked connector according to the Patent Document 1 in the stacking direction.

The stacked connector according to the present disclosure has been completed based on the above circumstances, and aims to downsize the stacked connector in the stacking direction.

### Means to Solve the Problem

A stacked connector according to the present disclosure includes: a first housing that has a flat shape; and a second housing that has a flat shape and is stacked on the first housing, the first housing has a first elastic locking piece that is elastically deformable and extends in a cantilever-like shape in a direction that intersects a stacking direction in which the first housing and the second housing are stacked, and a first locking portion that is not elastically deformable, the second housing has a second elastic locking piece that is elastically deformable and extends in a cantilever-like shape in a direction that intersects the stacking direction, and a second locking portion that is not elastically deformable, and the first housing and the second housing are held in a stacked state by the first elastic locking piece and the second locking portion engaging with each other or the second elastic locking piece and the first locking portion engaging with each other.

### Effect of the Invention

According to the present disclosure, it is possible to realize downsizing in the stacking direction.

### BRIEF DESCRIPTION OF THE DRAWINGS

FIG. 1 is a perspective view showing a stacked connector according to a first embodiment, viewed diagonally from the top front left.

FIG. 2 is a perspective view showing the stacked connector in a disassembled state, viewed diagonally from the top front right.

FIG. 3 is a perspective view of a second cover viewed diagonally from the bottom front left.

FIG. 4 is a perspective view of a first housing viewed diagonally from the top front right.

FIG. 5 is a perspective view of the first housing viewed diagonally from the bottom front left.

FIG. 6 is a perspective view of a second housing viewed diagonally from the top front right.

FIG. 7 is a perspective view of the second housing viewed diagonally from the bottom front left.

FIG. 8 is a perspective view of a terminal fitting viewed diagonally from the top front right.

FIG. 9 is a perspective view of the terminal fitting viewed diagonally from the bottom front left.

FIG. 10 is a perspective view of the first housing to which terminal fittings are attached, viewed diagonally from the top front right.

FIG. 11 is a perspective view of the second housing to which terminal fittings are attached, viewed diagonally from the top front right.

FIG. 12 is a perspective view of the first housing and the second housing in the middle of assembly, viewed diagonally from the top front right.

FIG. 13 is a perspective view of the first housing and the second housing in an assembled state, viewed diagonally from the top front right.

FIG. 14 is a front cross-sectional view of the first and second housings in an assembled state.

FIG. 15 is a cross-sectional view taken along the line A-A in FIG. 14.

### DETAILED DESCRIPTION TO EXECUTE THE INVENTION

### Description of Embodiments according to Present Disclosure

First, embodiments of the present disclosure will be listed and described.
(1) A stacked connector according to the present disclosure is a stacked connector including: a first housing that has a flat shape; and a second housing that has a flat shape and is stacked on the first housing, the first housing has a first elastic locking piece that is elastically deformable and extends in a cantilever-like shape in a direction orthogonal to a stacking direction in which the first housing and the second housing are stacked, and a first locking portion that is not elastically deformable, the second housing has a second elastic locking piece that is elastically deformable and extends in a cantilever-like shape in a direction that intersects the stacking direction, and a second locking portion that is not elastically deformable, and the first housing and the second housing are held in a stacked state by the first elastic locking piece and the second locking portion engaging with each other or the second elastic locking piece and the first locking portion engaging with each other. The first elastic locking piece and the second elastic locking piece each extend in a cantilever-like shape in a direction that intersects the stacking direction of the first housing and the second housing. Compared to a stacked connector in which the first elastic locking piece and the second elastic locking piece extend in the stacking direction, the stacked connector according to the present disclosure can be downsized in the stacking direction.
(2) It is preferable that the first elastic locking piece is disposed along an outer surface that is parallel to the stacking direction, of the first housing, and the second elastic locking piece is disposed along an outer surface that is parallel to the stacking direction, of the second housing. With this configuration, compared to a stacked connector in which the first elastic locking piece and the second elastic locking piece protrude at right angles from the outer surfaces parallel to the stacking direction, of the first housing and the second housing, the stacked connector can be downsized in a stacking direction view in which the two housings are viewed in the stacking direction.
(3) It is preferable that a relative movement direction in which the first housing and the second housing move relative to each other when the first elastic locking piece engages with the second locking portion or when the second elastic locking piece engages with the first locking portion is parallel to a direction in which the first elastic locking piece and the second elastic locking piece extend. With this configuration, when the first elastic locking piece and the second locking portion are locked to each other, the first elastic locking piece can be prevented from being elastically deformed in a twisting manner. When the second elastic locking piece and the first locking portion are locked to each other, the second elastic locking piece can be prevented from being elastically deformed in a twisting manner.
(4) In (3), it is preferable that the first housing and the second housing are each provided with a guide portion that extends in a direction parallel to the relative movement direction of the first housing and the second housing. With this configuration, the positional relationship between the first housing and the second housing during a relative movement is stabilized by the guide portions. Therefore, the first elastic locking piece and the second locking portion can be reliably locked to each other, and the second elastic locking piece and the first locking portion can be reliably locked to each other.
(5) In (4), it is preferable that a guide length of each guide portion is shorter than a total length of the first housing or a total length of the second housing in a lengthwise direction of the guide portion. With this configuration, the amount of sliding of the first housing and the second housing is small, and therefore the workability when attaching the two housings is high.
(6) It is preferable that the first housing and the second housing are each provided with a terminal housing portion that houses a terminal fitting in such a manner that the terminal fitting is exposed in the stacking direction. With this configuration, compared to a stacked connector in which the terminal fittings are housed without being exposed in the stacking direction, the stacked connector can be downsized in the stacking direction.

### Details of Embodiments According to Present Disclosure

### First Embodiment

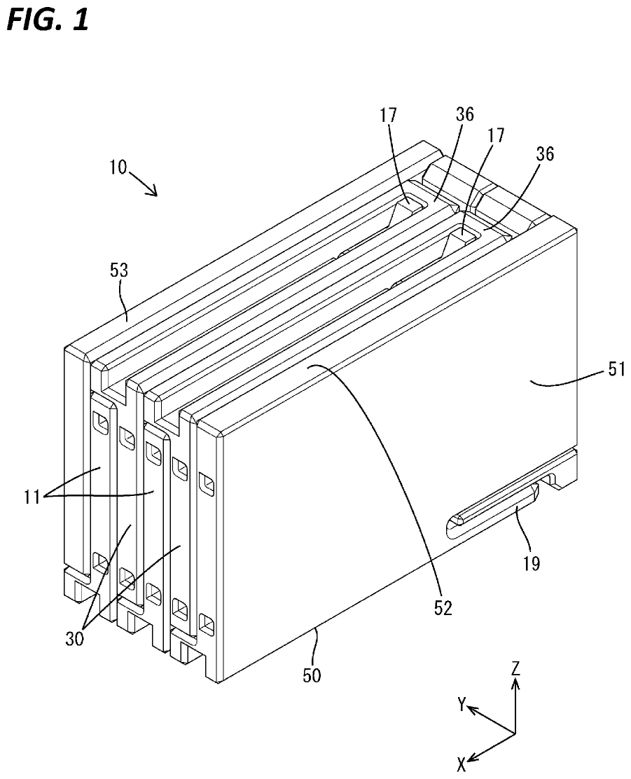

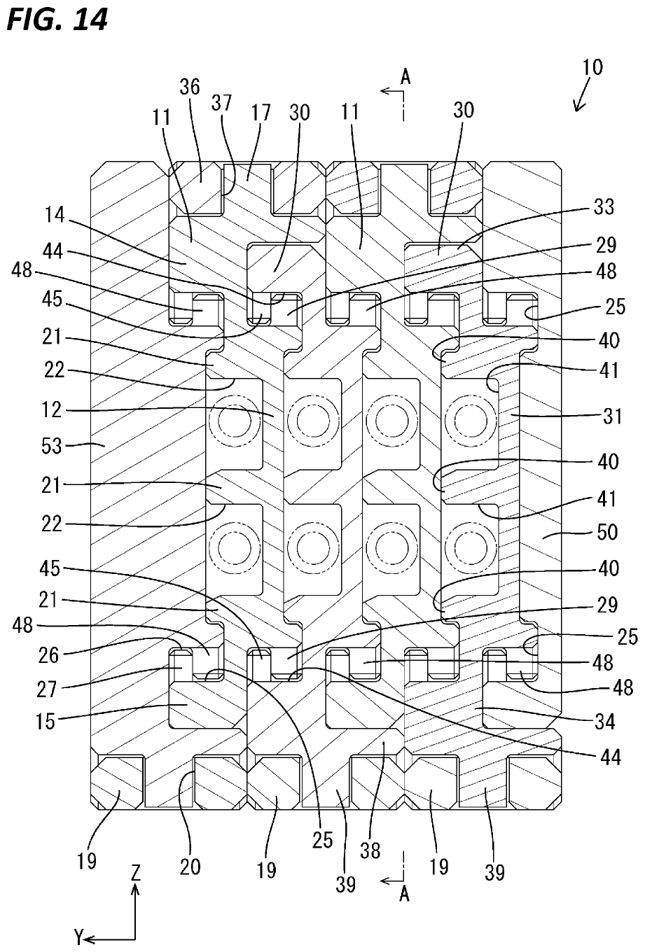

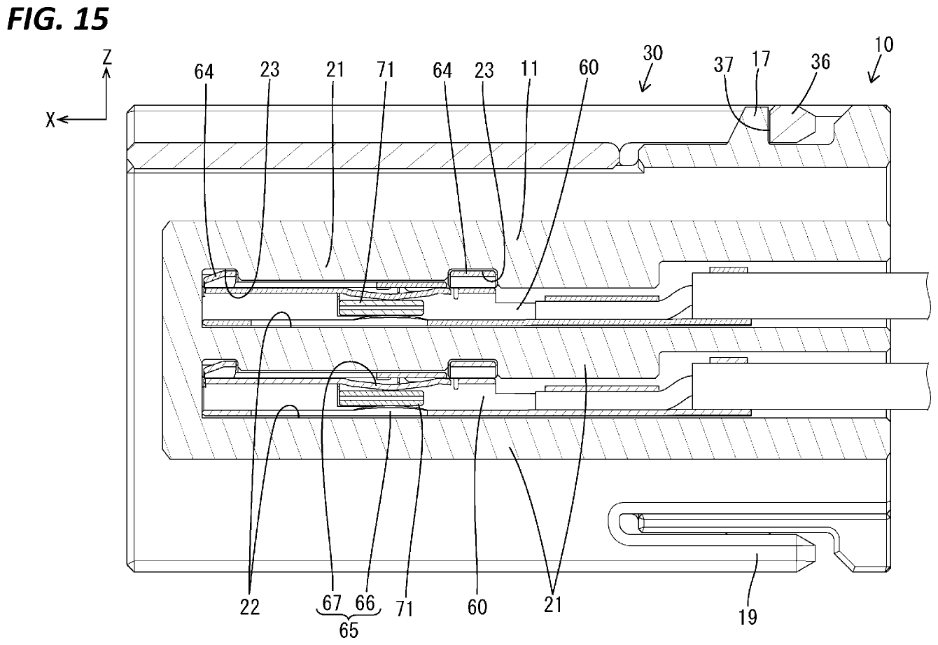

A first embodiment embodying the present disclosure will be described with reference to FIGS. 1 to 15. Note that the present invention is not limited to these examples, but is indicated by the scope of the claims, and is intended to include all changes within the meaning and range equivalent to the scope of the claims. In the first embodiment, regarding the front-rear direction, the side indicated by the X-axis in FIGS. 1 to 13 and 15 is defined as the front. Regarding the left-right direction, the side indicated by the Y-axis in FIGS. 1 to 14 is defined as the right. Regarding the top-bottom direction, the side indicated by the Z-axis in FIGS. 1 to 15 is defined as the top.

### Overview Of Stacked Connector

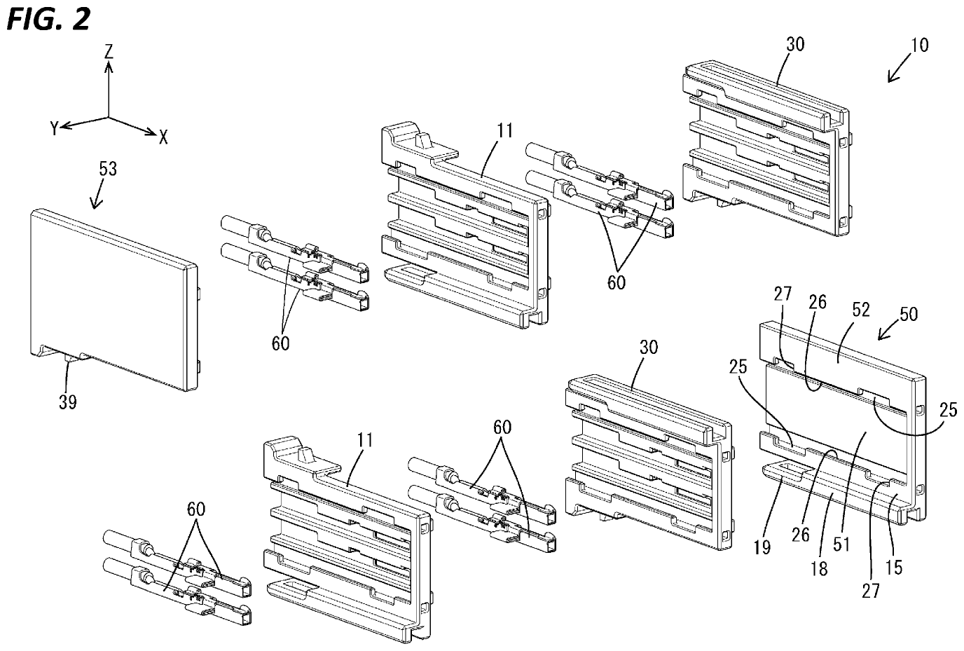

The stacked connector according to the first embodiment functions as a joint connector in a CAN (Controller Area Network) mounted on a vehicle, a transmission line routed in a non-vehicle object, or the like. As shown in FIG. 1, the stacked connector has a parallelopiped shape as a whole. As shown in FIG. 2, one stacked connector is formed by attaching one stacked housing 10 and a plurality of pairs of terminal fittings 60 to each other. One stacked housing 10 is formed by stacking a plurality of first housings 11, a plurality of second housings 30, one first cover 50, and one second cover 53 in the left-right direction and attaching them to each other. The number of first housings 11, the number of second housings 30, and the number of pairs of terminal fittings 60 are the same.

In the stacked housing 10 in an assembled state, the first cover 50 is disposed at the leftmost position in the stacked housing 10, and the second cover 53 is disposed at the rightmost position in the stacked housing 10. A second housing 30 is positioned to the right of the first cover 50, and a first housing 11 is positioned to the left of the second cover 53. The same number of first housings 11 and second housings 30 are alternately arranged between the first cover 50 and the second cover 53 in the left-right direction.

### First Housings 11

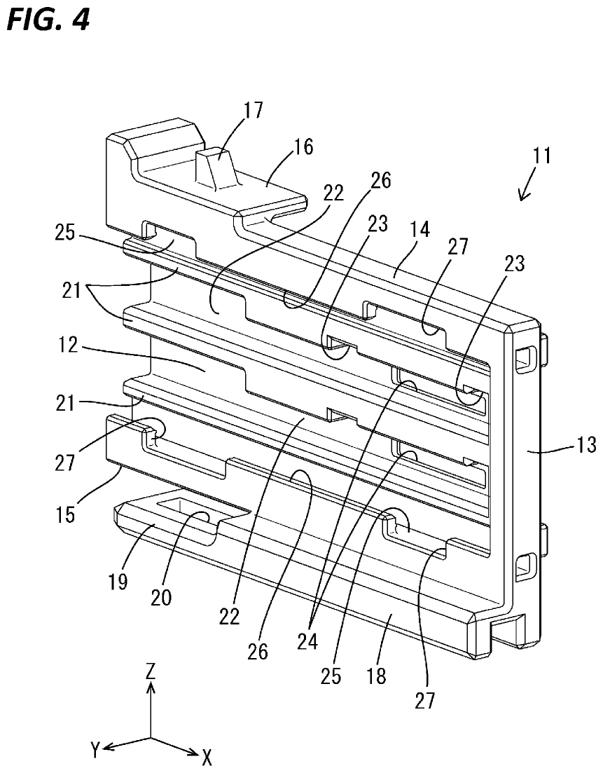

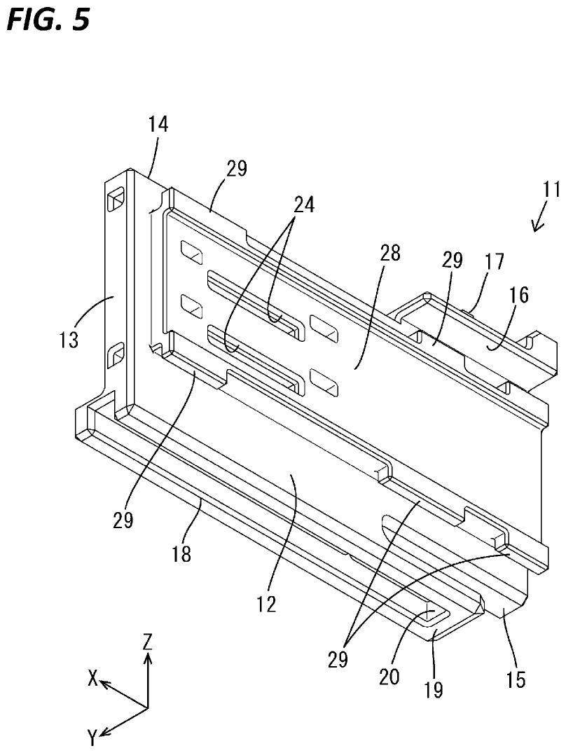

Each first housing 11 is a single component made of a synthetic resin. As shown in FIGS. 4 and 5, each first housing 11 has a flat shape in which the width in the left-right direction is smaller than the depth in the front-rear direction and the height in the top-bottom direction. Each first housing 11 includes a first plate-shaped base portion 12, a first front wall portion 13, a first upper wall portion 14, a first lower wall portion 15, a first widened portion 18, and a first elastic locking piece 19. In a side view of the first housing 11 in the left-right direction, the first plate-shaped base portion 12 has a rectangular shape. The first front wall portion 13 has an elongated shape in the top-bottom direction, and is disposed along the front edge of the first plate-shaped base portion 12. A right-side portion of the first front wall portion 13 protrudes to the right from the first plate-shaped base portion 12 in a rib shape.

The first upper wall portion 14 has an elongated shape in the front-rear direction, and is disposed along the upper edge of the first plate-shaped base portion 12. A right-side portion of the first upper wall portion 14 protrudes to the right from the first plate-shaped base portion 12 in a rib shape. A first protruding portion 16 is formed at a rear end portion of the first upper wall portion 14. A left-side portion of the first protruding portion 16 protrudes to the left from the first plate-shaped base portion 12. A first locking portion 17 having a protruding shape, which protrudes upward, is formed on the upper surface (outer surface) of the first protruding portion 16.

The first lower wall portion 15 has an elongated shape in the front-rear direction, and is disposed along the lower edge of the first plate-shaped base portion 12. A right-side portion of the first lower wall portion 15 protrudes to the right from the first plate-shaped base portion 12 in a rib shape. The first widened portion 18 is disposed along the outer surface (lower surface) of the first lower wall portion 15. A right-side portion of the first widened portion 18 protrudes to the right relative to the first lower wall portion 15 in a rib shape. An area of the first widened portion 18 other than a rear end portion thereof is continuous with the outer surface of the first lower wall portion 15.

The rear end portion of the first widened portion 18 functions as the first elastic locking piece 19. The first elastic locking piece 19 is spaced downward from the outer surface (lower surface) of the first lower wall portion 15, and has a shape that extends rearward in the manner of a cantilever. The direction in which the first elastic locking piece 19 extends is a direction that is orthogonal to the stacking direction of the stacked housing 10 (the left-right direction) and that extends along the outer surface (lower surface) of the first housing 11. The first elastic locking piece 19 has a first locking hole 20, and can be elastically displaced downward, with the front end of the first elastic locking piece 19 serving as a supporting point.

Three first partition walls 21 are formed on the right surface of the first plate-shaped base portion 12 at intervals in the top-bottom direction. The range in which the first partition walls 21 are formed in the front-rear direction is the range from the first front wall portion 13 to the rear end of the first plate-shaped base portion 12. A pair of upper and lower first terminal housing portions 22 partitioned by the three first partition walls 21 are formed in the first plate-shaped base portion 12. Each first terminal housing portion 22 is elongated in the front-rear direction and has a cavity that is open to the right of the first housing 11. A pair of front and rear first positioning recesses 23 are formed in the upper surface of each first terminal housing portion 22. A pair of upper and lower first communication holes 24 that extend through the first plate-shaped base portion 12 in the left-right direction are formed in the first plate-shaped base portion 12. The upper first communication hole 24 is in communication with the upper first terminal housing portion 22. The lower first communication hole 24 is in communication with the lower first terminal housing portion 22.

A pair of upper and lower first guide grooves 25 that are elongated in the front-rear direction are formed in the right surface of the first plate-shaped base portion 12. The upper first guide groove 25 is constituted by the right surface of the first plate-shaped base portion 12, the first upper wall portion 14, and a first guide wall 26 that protrudes downward from the right edge of the first upper wall portion 14. The lower first guide groove 25 is constituted by the right surface of the first plate-shaped base portion 12, the first lower wall portion 15, and a first guide wall 26 that protrudes upward from the right edge of the first lower wall portion 15. The first guide wall 26 has two first notches 27 spaced apart from each other in the front-rear direction.

The first plate-shaped base portion 12 has a first thick portion 28 that extends to the left from the left surface of the first plate-shaped base portion 12. The upper surface of the first thick portion 28 has three first guide ribs 29 that protrude upward and are spaced apart from each other in the front-rear direction. The lower surface of the first thick portion 28 has three first guide ribs 29 that protrude downward and are spaced apart from each other in the front-rear direction. The first guide grooves 25, the first guide walls 26, and the first guide ribs 29 serve as guide portions for stabilizing the positional relationship between the first housing 11 and the second housing 30 when attaching the two housings 11 and 30 to each other.

### Second Housings 30

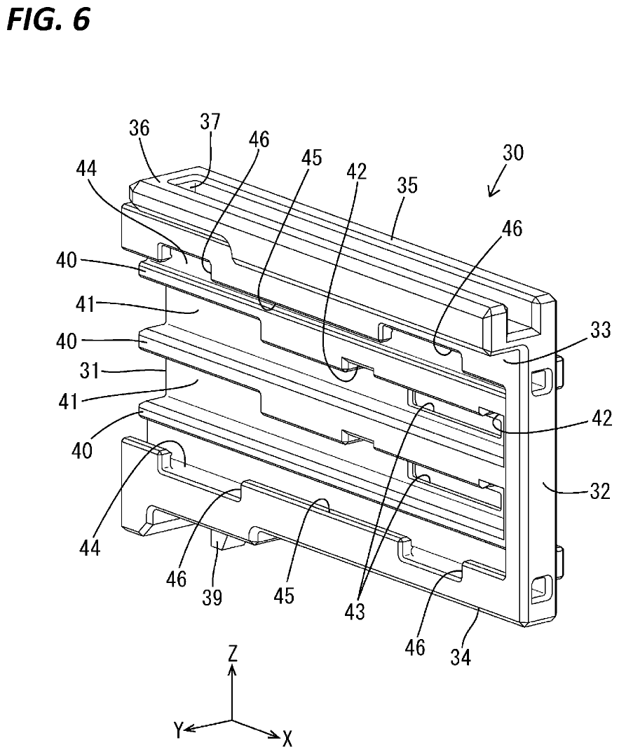

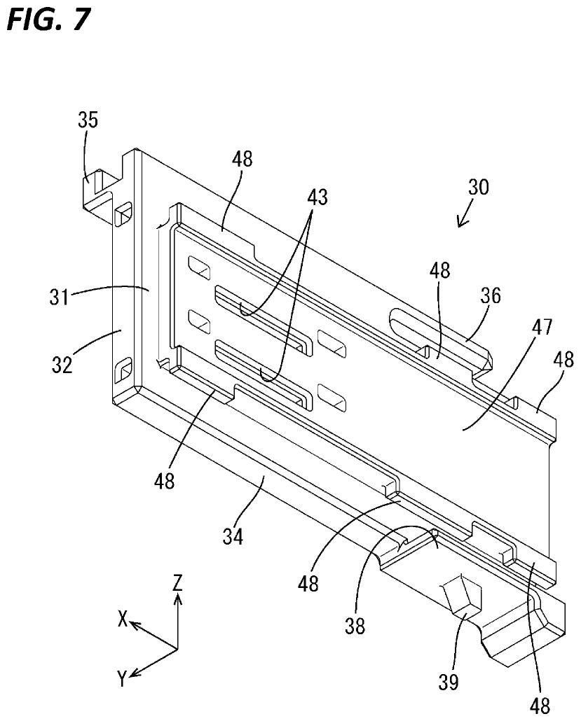

Each second housing 30 is a single component made of a synthetic resin. As shown in FIGS. 6 and 7, each second housing 30 has a flat shape in which the width in the left-right direction is smaller than the depth in the front-rear direction and the height in the top-bottom direction. Each second housing 30 includes a second plate-shaped base portion 31, a second front wall portion 32, a second upper wall portion 33, a second lower wall portion 34, a second widened portion 35, and a second elastic locking piece 36. In a side view of the second housing 30 in the left-right direction, the second plate-shaped base portion 31 has a rectangular shape. The second front wall portion 32 has an elongated shape in the top-bottom direction, and is disposed along the front edge of the second plate-shaped base portion 31. A right-side portion of the second front wall portion 32 protrudes to the right from the second plate-shaped base portion 31 in a rib shape.

The second upper wall portion 33 has an elongated shape in the front-rear direction, and is disposed along the upper edge of the second plate-shaped base portion 31. A right-side portion of the second upper wall portion 33 protrudes to the right from the second plate-shaped base portion 31 in a rib shape. The second widened portion 35 is disposed along the outer surface (upper surface) of the second upper wall portion 33. A right-side portion of the second widened portion 35 protrudes to the right relative to the second upper wall portion 33 in a rib shape. An area of the second widened portion 35 other than a rear end portion thereof is continuous with the outer surface of the second upper wall portion 33.

The rear end portion of the second widened portion 35 functions as the second elastic locking piece 36. The second elastic locking piece 36 is spaced upward from the outer surface (lower surface) of the second upper wall portion 33, and has a shape that extends rearward in the manner of a cantilever. The direction in which the second elastic locking piece 36 extends is a direction that is orthogonal to the stacking direction of the stacked housing 10 (the left-right direction) and that extends along the outer surface (upper surface) of the second housing 30. The second elastic locking piece 36 has a second locking hole 37, and can be elastically displaced upward, with the front end of the second elastic locking piece 36 serving as a supporting point.

The second lower wall portion 34 has an elongated shape in the front-rear direction, and is disposed along the lower edge of the second plate-shaped base portion 31. A right-side portion of the second lower wall portion 34 protrudes to the right from the second plate-shaped base portion 31 in a rib shape. A second protruding portion 38 is formed on a rear end portion of the second lower wall portion 34. A left-side portion of the second protruding portion 38 protrudes to the left from the second plate-shaped base portion 31. A second locking portion 39 having a protruding shape, which protrudes downward, is formed on the lower surface (outer surface) of the second protruding portion 38.

The direction in which the first elastic locking piece 19 extends and the direction in which the second elastic locking piece 36 extends are the same (rearward). The position of the first elastic locking piece 19 of the first housing 11 and the position of the second elastic locking piece 36 of the second housing 30 are opposite to each other in the top-bottom direction. The position of the first locking portion 17 of the first housing 11 and the position of the second locking portion 39 of the second housing 30 are opposite to each other in the top-bottom direction.

Three second partition walls 40 are formed on the right surface of the second plate-shaped base portion 31 at intervals in the top-bottom direction. The range in which the second partition walls 40 are formed in the front-rear direction is the range from the second front wall portion 32 to the rear end of the second plate-shaped base portion 31. A pair of upper and lower second terminal housing portions 41 partitioned by the three second partition walls 40 are formed in the second plate-shaped base portion 31. Each second terminal housing portion 41 is elongated in the front-rear direction and has a cavity that is open to the right of the second housing 30. A pair of front and rear second positioning recesses 42 are formed in the upper surface of each second terminal housing portion 41. A pair of upper and lower second communication holes 43 that extend through the second plate-shaped base portion 31 in the left-right direction are formed in the second plate-shaped base portion 31. The upper second communication hole 43 is in communication with the upper second terminal housing portion 41. The lower second communication hole 43 is in communication with the lower second terminal housing portion 41.

A pair of upper and lower second guide grooves 44 that are elongated in the front-rear direction are formed in the right surface of the second plate-shaped base portion 31. The upper second guide groove 44 is constituted by the right surface of the second plate-shaped base portion 31, the second upper wall portion 33, and a second guide wall 45 that protrudes downward from the right edge of the second upper wall portion 33. The lower second guide groove 44 is constituted by the right surface of the second plate-shaped base portion 31, the second lower wall portion 34, and a second guide wall 45 that protrudes upward from the right edge of the second lower wall portion 34. The second guide wall 45 has two second notches 46 spaced apart from each other in the front-rear direction.

The second plate-shaped base portion 31 has a second thick portion 47 that extends to the left from the left surface of the second plate-shaped base portion 31. The upper surface of the second thick portion 47 has three second guide ribs 48 that protrude upward and are spaced apart from each other in the front-rear direction. The lower surface of the second thick portion 47 has three second guide ribs 48 that protrude downward and are spaced apart from each other in the front-rear direction. The second guide grooves 44, the second guide walls 45, and the second guide ribs 48 serve as guide portions for stabilizing the positional relationship between the first housing 11 and the second housing 30 when attaching the two housings 11 and 30 to each other.

### First Cover 50

The first cover 50 is a single component made of a synthetic resin. As shown in FIG. 2, the first cover 50 has a plate shape in which the width in the left-right direction is smaller than the depth in the front-rear direction and the height in the top-bottom direction. The first cover 50 includes a first substrate portion 51, an upper edge portion 52, the first lower wall portion 15, the first widened portion 18, and the first elastic locking piece 19. In a side view of the first cover 50 in the left-right direction, the first substrate portion 51 has a rectangular shape. The upper edge portion 52 has an elongated shape in the front-rear direction, and is disposed along the upper edge of the first substrate portion 51. A right-side portion of the upper edge portion 52 protrudes to the right from the first substrate portion 51.

The first lower wall portion 15 of the first cover 50 has the same shape as the first lower wall portion 15 of each first housing 11. The first lower wall portion 15 has an elongated shape in the front-rear direction, and is disposed along the lower edge of the first substrate portion 51. A right-side portion of the first lower wall portion 15 protrudes to the right from the first substrate portion 51 in a rib shape. The shape of the first widened portion 18 in the first cover 50 and the positional relationship between the first widened portion 18 and the first lower wall portion 15 are the same as those in each first housing 11. The rear end portion of the first widened portion 18 functions as the first elastic locking piece 19. The shape of the first elastic locking piece 19 in the first cover 50, the positional relationship between the first elastic locking piece 19 and the first widened portion 18, and the positional relationship between the first elastic locking piece 19 and the first lower wall portion 15 are the same as those in each first housing 11.

A pair of upper and lower first guide grooves 25 that are elongated in the front-rear direction are formed in the right surface of the first substrate portion 51. The shape of the first guide grooves 25 of the first cover 50 is essentially the same as that of the first guide grooves 25 of each first housing 11. The upper first guide groove 25 is constituted by the right surface of the first substrate portion 51, the upper edge portion 52, and a first guide wall 26 that protrudes downward from the right edge of the upper edge portion 52. The lower first guide groove 25 is constituted by the right surface of the first substrate portion 51, the first lower wall portion 15, and a first guide wall 26 that protrudes upward from the right edge of the first lower wall portion 15. Each first guide wall 26 has two first notches 27 spaced apart from each other in the front-rear direction. The first guide grooves 25 and the first guide walls 26 of the first cover 50 and the second guide ribs 48 of the second housings 30 serve as guide portions for stabilizing the positional relationship between the second housing 30 and the first cover 50 when attaching the second housing 30 and the first cover 50 to each other.

### Second Cover 53

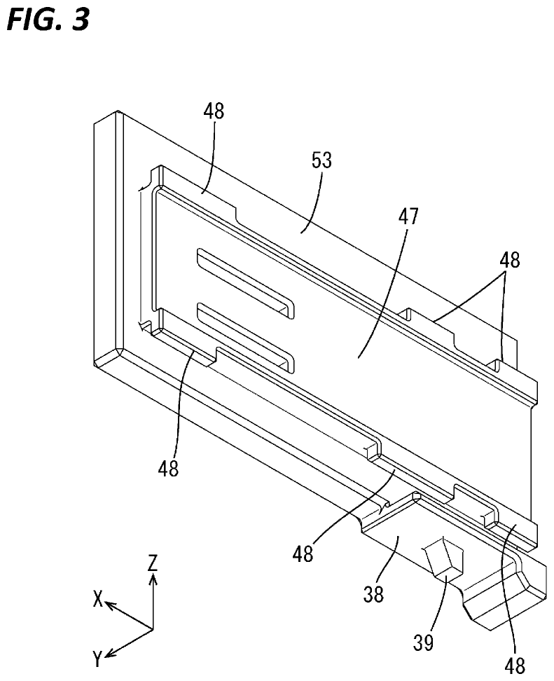

The second cover 53 is a single component made of a synthetic resin. As shown in FIGS. 2 and 3, the second cover 53 has a plate shape in which the width in the left-right direction is smaller than the depth in the front-rear direction and the height in the top-bottom direction. A second protruding portion 38 is formed at a rear end portion of the lower edge of the second cover 53. A left-side portion of the second protruding portion 38 protrudes to the left from the second plate-shaped base portion 31. A second locking portion 39 having a protruding shape, which protrudes downward, is formed on the lower surface (outer surface) of the second protruding portion 38. The second protruding portion 38 and the second locking portion 39 of the second cover 53 have the same shapes as the second protruding portion 38 and the second locking portion 39 of the second housings 30, respectively.

The second cover 53 has a second thick portion 47 that extends to the left from the left surface of the second cover 53. The upper surface of the second thick portion 47 has three second guide ribs 48 that protrude upward and are spaced apart from each other in the front-rear direction. The lower surface of the second thick portion 47 has three second guide ribs 48 that protrude downward and are spaced apart from each other in the front-rear direction. The second guide ribs 48 of the second cover 53 have the same shape as the second guide ribs 48 of the second housings 30. The second guide ribs 48 of the second cover 53 and the first guide grooves 25 and the first guide walls 26 of the first housings 11 serve as guide portions for stabilizing the positional relationship between the first housing 11 and the second cover 53 when attaching the first housing 11 and the second cover 53 to each other.

### Terminal Fittings 60

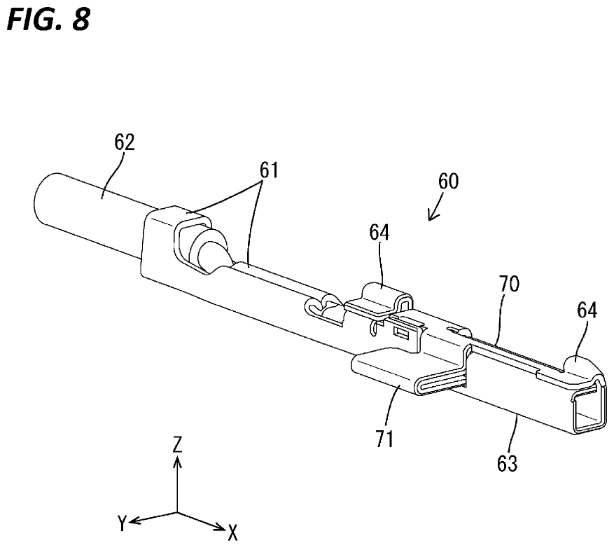

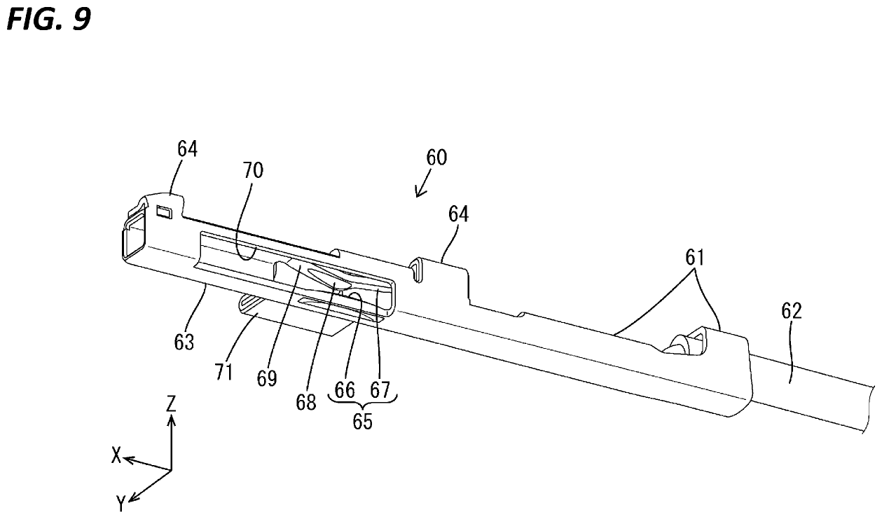

Each terminal fitting 60 is a single component formed by, for example, bending a metal plate member. As shown in FIGS. 8 and 9, each terminal fitting 60 has an elongated shape in the front-rear direction as a whole. An open barrel-shaped crimp portion 61 is formed in a rear end-side area of each terminal fitting 60. The terminal fitting 60 and an electric wire 62 are connected to each other by crimping the crimp portion 61 to the front end of the electric wire 62.

A rectangular cylindrical terminal body portion 63 is formed in a front end-side area of each terminal fitting 60. A pair of front and rear positioning protrusions 64 that each have a protruding shape are formed on the terminal body portion 63. The pair of positioning protrusions 64 protrude upward from a front end portion and a rear end portion of the upper surface of the terminal body portion 63. A connecting portion 65 that is constituted by a pressure receiving portion 66 and an elastic contact piece 67 is provided inside the terminal body portion 63. The pressure receiving portion 66 has a shape that protrudes upward from a lower plate portion included in the terminal body portion 63. The elastic contact piece 67 includes a contact portion 68 and a guide surface 69 disposed forward of the contact portion 68. The contact portion 68 and the pressure receiving portion 66 are disposed so as to face each other in the top-bottom direction.

An opening 70 bringing the inside and outside of the terminal body portion 63 into communication is formed in a left side plate portion included in the terminal body portion 63. The opening 70 has an elongated slit shape in the front-rear direction. The range in which the opening 70 is formed in the front-rear direction is the range from a position located forward of the front end of the guide surface 69 to a position located rearward of the contact portion 68. A protrusion 71 that protrudes to the right relative to the right outer surface of the terminal body portion 63 is formed on the terminal body portion 63. The protrusion 71 has a bent shape formed by folding one plate-shaped portion. The protrusion 71 and the contact portion 68 are disposed in the same area in the front-rear direction.

### Procedure for Assembling Stacked Connector

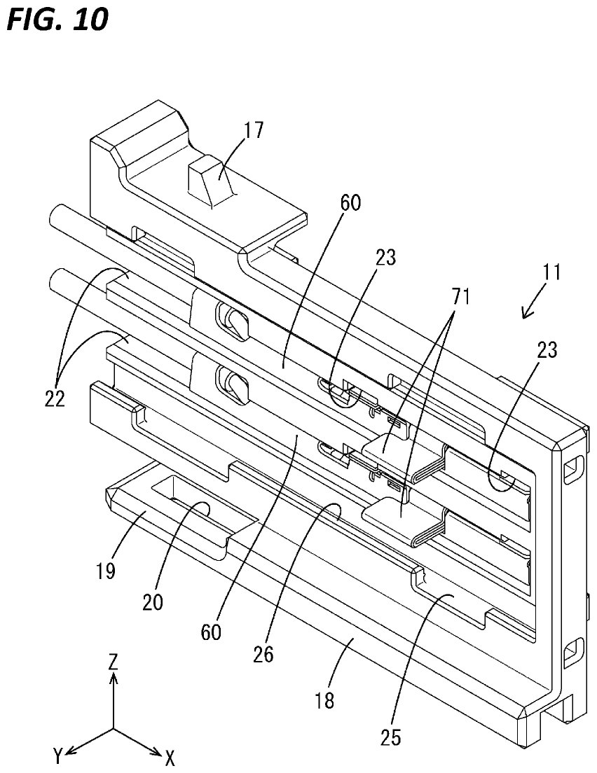

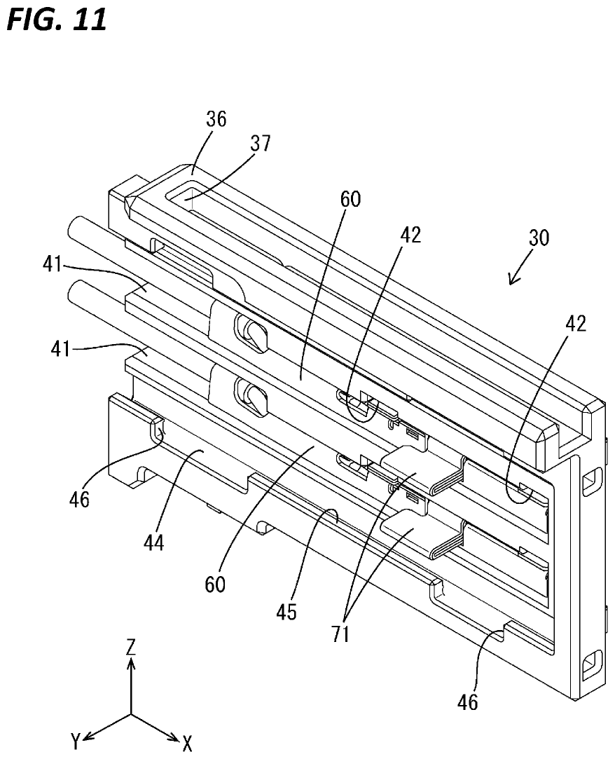

As shown in FIGS. 10 and 11, terminal fittings 60 are housed in the first terminal housing portions 22 and thereby attached to the first housing 11, and terminal fittings 60 are housed in the second terminal housing portions 41 and thereby attached to the second housing 30. The attached terminal fittings 60 are exposed on the right side of the first housing 11 or the second housing 30. The positioning protrusions 64 are fitted into the first positioning recesses 23 or the second positioning recesses 42, and thus the attached terminal fittings 60 are positioned with respect to the first housing 11 or the second housing 30 in the front-rear direction. Fitting between the positioning protrusions 64 and the first positioning recesses 23 keeps the terminal fittings 60 attached to the first housing 11. Fitting between the positioning protrusions 64 and the second positioning recesses 42 keeps the terminal fittings 60 attached to the second housing 30.

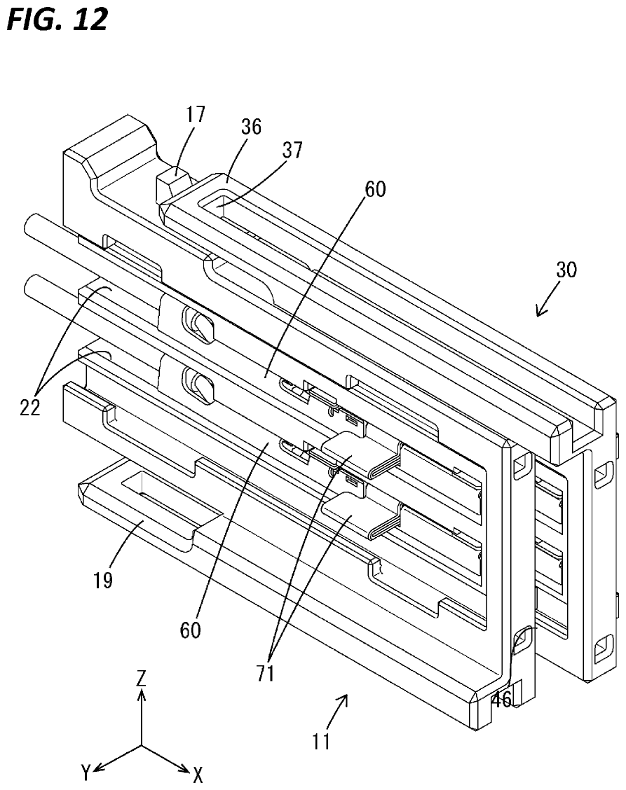

Next, the first housing 11 and the second housing 30 are attached to each other. At this time, as shown in FIG. 12, the first housing 11 is disposed on the right side, and the second housing 30 is disposed on the left side with the second housing 30 disposed slightly forward of the first housing 11. While maintaining this positional relationship, the first housing 11 and the second housing 30 are brought closer to each other in the left-right direction, and the first guide ribs 29 are inserted into the second guide grooves 44 from the second notches 46 of the second guide wall 45. This state is referred to as a temporarily assembled state of the two housings 11 and 30.

When the two housings 11 and 30 are in the temporarily assembled state, a rear end portion of the second elastic locking piece 36 is disposed forward of the first locking portion 17 so as to be adjacent thereto. The protrusions 71 of the terminal fittings 60 attached to the second housing 30 pass through the first communication holes 24 of the first housing 11 and the openings 70 of the terminal fittings 60 attached to the first housing 11, and enter into the terminal body portions 63 of the terminal fittings 60 attached to the first housing 11. In each terminal body portion 63, the protrusion 71 is located forward of the contact portion 68 of the elastic contact piece 67.

Next, the second housing 30 is slid rearward from the temporarily assembled state relative to the first housing 11. In the process of relatively moving the two housings 11 and 30 in the front-rear direction, the first guide ribs 29 housed in the second guide grooves 44 slide against the second guide walls 45, thereby exhibiting a guiding function. This guiding function restricts the two housings 11 and 30 from separating in the left-right direction (i.e., the stacking direction), and also restricts the two housings 11 and 30 from moving relative to each other in the top-bottom direction (i.e., a direction orthogonal to the stacking direction).

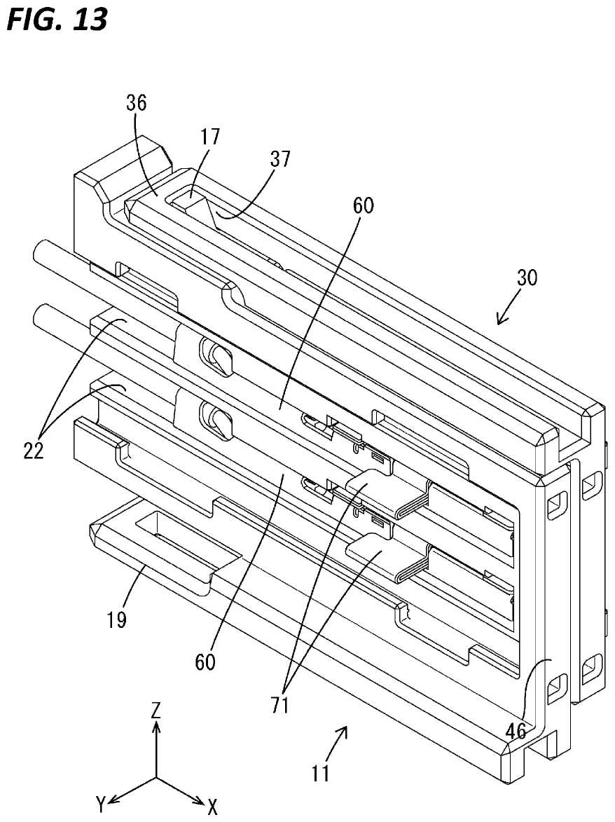

While the two housings 11 and 30 move relative to each other, the second elastic locking piece 36 moves up onto the first locking portion 17 and is elastically deformed upward. When the two housings 11 and 30 reach the proper assembled state, the second elastic locking piece 36 passes through the first locking portion 17 and elastically returns to its original state, and the second locking hole 37 and the first locking portion 17 are fitted to each other as shown in FIG. 13. As a result of this fitting, the two housings 11 and 30 are locked to each other in the proper assembled state. The protrusion 71 is inserted between the elastic contact piece 67 and the pressure receiving portion 66 and comes into contact with the contact portion 68 due to the elastic restoring force of the elastic contact piece 67. As a result, the terminal fittings 60 of the first housing 11 and the terminal fittings 60 of the second housing 30 are connected to one another.

After one pair of a first housing 11 and a second housing 30 are attached to each other as described above, the other pairs of a first housing 11 and a second housing 30 are attached in the same manner. After two pairs of a first housing 11 and a second housing 30 have been attached, the first housing 11 of one of the pairs and the second housing 30 of the other of the pairs are attached to each other. At this time, the first housing 11 is disposed on the left side, the second housing 30 is disposed on the right side, and the first housing 11 is disposed slightly forward of the second housing 30. While maintaining this positional relationship, the first housing 11 and the second housing 30 are brought closer to each other in the left-right direction, and the two housings 11 and 30 are brought into a temporarily assembled state by inserting the second guide ribs 48 into the first guide grooves 25 from the first notches 27 of the first guide walls 26.

When the two housings 11 and 30 are in the temporarily assembled state, a rear end portion of the first elastic locking piece 19 is disposed forward of the second locking portion 39 so as to be adjacent thereto. The protrusions 71 of the crimp portions 61 attached to the first housing 11 pass through the second communication holes 43 of the second housing 30 and the openings 70 of the terminal fittings 60 attached to the second housing 30, and enter into the terminal body portions 63 of the terminal fittings 60 attached to the second housing 30. In each terminal body portion 63, the protrusion 71 is located forward of the contact portion 68 of the elastic contact piece 67.

Next, the first housing 11 is slid rearward relative to the second housing 30. In the process of relatively moving the two housings 11 and 30 in the front-rear direction, the second guide ribs 48 housed in the first guide grooves 25 slide against the first guide walls 26, thereby exhibiting a guiding function. This guiding function restricts the two housings 11 and 30 from separating in the left-right direction (i.e., the stacking direction), and also restricts the two housings 11 and 30 from moving relative to each other in the top-bottom direction (i.e., a direction orthogonal to the stacking direction).

While the two housings 11 and 30 move relative to each other, the first elastic locking piece 19 moves up onto the second locking portion 39 and is elastically deformed downward. When the two housings 11 and 30 reach the proper assembled state, the first elastic locking piece 19 passes through the second locking portion 39 and elastically restores to its original state, and the first locking hole 20 and the second locking portion 39 are fitted to each other. As a result of this fitting, the two housings 11 and 30 are locked to each other in the proper assembled state.

After the two pairs of a first housing 11 and a second housing 30 have been attached as described above, the two first housings 11 and the two second housings 30 are stacked alternately in the left-right direction. Thereafter, the second cover 53 is attached to the first housing 11 located at the right end in the stacking direction. During attachment, the first housing 11 and the second cover 53 are brought into a temporarily assembled state by the same procedure as when the first housing 11 and the second housing 30 are attached to each other. Next, a guiding function is exhibited by the first guide grooves 25 and first guide walls 26 of the first housing 11 and the second guide ribs 48 of the second cover 53, and the first housing 11 and the second cover 53 are moved in the front-rear direction relative to each other. As a result of this relative movement, the first elastic locking piece 19 of the first housing 11 and the second locking portion 39 of the second cover 53 are fitted to each other, and the first housing 11 and the second cover 53 are locked to each other in the proper assembled state.

Next, the second housing 30 located at the left end in the stacking direction and the first cover 50 are attached to each other. During attachment, the second housing 30 and the first cover 50 are brought into a temporarily assembled state by the same procedure as when the first housing 11 and the second housing 30 are attached to each other. Next, a guiding function is exhibited by the first guide grooves 25 and first guide walls 26 of the first housing 11 and the second guide ribs 48 of the second housings 30, and the second housing 30 and the first cover 50 are moved in the front-rear direction relative to each other. As a result of this relative movement, the first elastic locking piece 19 of the first cover 50 and the second locking portion 39 of the second housing 30 are fitted to each other, and the second housings 30 and the first cover 50 are locked to each other in the proper assembled state. Through the above procedure, assembly of the stacked connector is complete.

The procedure for assembling the stacked connector is not limited to the above procedure. The order of attaching the first housing 11 and the second housing 30, the first housing 11 and the second cover 53, and the second housing 30 and the first cover 50 can be set as necessary.

### Effects of First Embodiment

The stacked connector according to the first embodiment includes: a first housing 11 that has a flat shape; and a second housing 30 that has a flat shape and is stacked on the first housing 11. The first housing 11 has a first elastic locking piece 19 that is elastically deformable and extends in a cantilever-like shape in a direction (rearward) orthogonal to a stacking direction (a left-right direction) in which the two housings 11 and 30 are stacked, and a first locking portion 17 that is not elastically deformable. The second housing 30 has a second elastic locking piece 36 that is elastically deformable and extends in a cantilever-like shape in a direction (rearward) that intersects the stacking direction, and a second locking portion 39 that is not elastically deformable. The two housings 11 and 30 are held in a stacked state by the first elastic locking piece 19 and the second locking portion 39 engaging with each other or the second elastic locking piece 36 and the first locking portion 17 engaging with each other.

The first elastic locking piece 19 and the second elastic locking piece 36 of the stacked connector according to the first embodiment each extend in a cantilever-like shape in a rearward direction that intersects the stacking direction of the first housing 11 and the second housing 30. Compared to a stacked connector in which the first elastic locking piece and the second elastic locking piece extend in a direction parallel to the stacking direction, the stacked connector according to the first embodiment can be downsized in the stacking direction.

The first elastic locking piece 19 is disposed along the outer surface (the lower surface) that is parallel to the stacking direction, of the first housing 11. The second elastic locking piece 36 is disposed along the outer surface (the upper surface) that is parallel to the stacking direction, of the second housing 30. With this configuration, compared to a stacked connector in which the first elastic locking piece and the second elastic locking piece protrude at right angles from the outer surfaces parallel to the stacking direction, of the first housing 11 and the second housing 30, the stacked connector can be downsized in a stacking direction view (a side view) in which the two housings 11 and 30 are viewed in the stacking direction.

A relative movement direction in which the first housing 11 and the second housing 30 move relative to each other when the first elastic locking piece 19 engages with the second locking portion 39 or when the second elastic locking piece 36 engages with the first locking portion 17 is a front-rear direction that is parallel to a direction (rearward) in which the first elastic locking piece 19 and the second elastic locking piece 36 extend. With this configuration, when the first elastic locking piece 19 and the second locking portion 39 are locked to each other, the first elastic locking piece 19 can be prevented from being elastically deformed in a twisting manner. Also, when the second elastic locking piece 36 and the first locking portion 17 are locked to each other, the second elastic locking piece 36 can be prevented from being elastically deformed in a twisting manner.

The first housing 11 and the second housing 30 are provided with first guide grooves 25, first guide walls 26, first guide ribs 29, second guide grooves 44, second guide walls 45, and second guide ribs 48, which serve as guide portions that extend in a direction parallel to the relative movement direction of the two housings 11 and 30. With this configuration, the positional relationship between the two housings 11 and 30 during relative movement is stabilized by the portions 25, 26, 29, 44, 45, and 48 constituting the guide portions. Therefore, the first elastic locking piece 19 and the second locking portion 39 can be reliably locked to each other, and the second elastic locking piece 36 and the first locking portion 17 can be reliably locked to each other.

A guide length of each guide portion, i.e., the length in the front-rear direction by which each of the two housings 11 and 30 is guided by the guide portion, is shorter than a total length (a depth dimension in the front-rear direction) of the two housings 11 and 30 in a lengthwise direction of the guide portion (the front-rear direction). With this configuration, the amount of relative movement of the two housings 11 and 30 is small in the process of transitioning the two housings 11 and 30 from the temporarily assembled state to the proper assembled state, and therefore the workability when attaching the two housings 11 and 30 to each other is high.

The first housing 11 and the second housing 30 are provided with a first terminal housing portion 22 and a second terminal housing portion 41 that each house a terminal fitting 60 in such a manner that the terminal fitting 60 is exposed in the stacking direction (to the right). With this configuration, compared to a stacked connector in which the terminal fittings 60 are housed without being exposed in the stacking direction, the stacked connector can be downsized in the stacking direction.

### Other Embodiments

The present invention is not limited to the embodiment described based on the above description and the drawings, but is indicated by the claims. The present invention includes meanings equivalent to the scope of the claims and all changes within the scope of the claims, and is intended to include the following embodiments.

In the first embodiment, the number of first housings included in one stacked connector is two, but the number of first housings included in one stacked connector may be one or three or more.

In the first embodiment, the number of second housings included in one stacked connector is two, but the number of second housings included in one stacked connector may be one or three or more.

In the first embodiment, the number of first housings and the number of second housings included in one stacked connector are the same, but the combination of the number of first housings and the number of second housings included in one stacked connector may be a combination in which the number of second housings is smaller than the number of first housings by one.

In the first embodiment, the first elastic locking piece is disposed along the outer surface (the lower surface) that is parallel to the stacking direction, of the first housing. However, the first elastic locking piece may protrude outward (downward) from the outer surface (the lower surface) of the first housing at a right angle.

In the first embodiment, the second elastic locking piece is disposed along the outer surface (the upper surface) that is parallel to the stacking direction, of the second housing. However, the second elastic locking piece may protrude outward (upward) from the outer surface (the upper surface) of the second housing at a right angle.

In the first embodiment, the elastic locking pieces and the locking portions are locked by moving the first housing and the second housing relative to each other in a direction (a front-rear direction) parallel to the direction in which the elastic locking pieces extend. However, the direction of relative movement of the first housing and the second housing when the elastic locking pieces and the locking portions are locked may be a direction (a left-right direction) that intersects the direction in which the elastic locking pieces extend.

The guide length of the guide portions (the guide walls and the guide ribs) may be the same as the total length of the first housing and the total length of the second housing (the length in the front-rear direction).

The first housing and the second housing may be housings that are not provided with guide portions (guide walls and guide ribs).

In the first embodiment, the first terminal housing portions of the first housing house the terminal fittings in an exposed state. However, the first terminal housing portions may house the terminal fittings in a non-exposed state.

In the first embodiment, the second terminal housing portions of the second housing house the terminal fittings in an exposed state. However, the second terminal housing portions may house the terminal fittings in a non-exposed state.

### LIST OF REFERENCE NUMERALS

10 Stacked Housing
11 First Housing
12 First Plate-Shaped Base Portion
13 First Front Wall Portion
14 First Upper Wall Portion
15 First Lower Wall Portion
16 First Protruding Portion
17 First Locking Portion
18 First Widened portion
19 First Elastic Locking Piece
20 First Locking Hole
21 First Partition Wall
22 First Terminal Housing Portion (Terminal Housing Portion)
23 First Positioning Recess
24 First Communication Hole
25 First Guide Groove (Guide Portion)
26 First Guide Wall (Guide Portion)
27 First Notch
28 First Thick Portion
29 First Guide Rib (Guide Portion)
30 Second Housing
31 Second Plate-Shaped Base Portion
32 Second Front Wall Portion
33 Second Upper Wall Portion
34 Second Lower Wall Portion
35 Second Widened portion
36 Second Elastic Locking Piece
37 Second Locking Hole
38 Second Protruding Portion
39 Second Locking Portion
40 Second Partition Wall
41 Second Terminal Housing Portion (Terminal Housing Portion)
42 Second Positioning Recess
43 Second Communication Hole
44 Second Guide Groove (Guide Portion)
45 Second Guide Wall (Guide Portion)
46 Second Notch
47 Second Thick Portion
48 Second Guide Rib (Guide Portion)
50 First Cover
51 First Substrate Portion
52 Upper Edge Portion
53 Second Cover
60 Terminal Fitting
61 Crimp Portion
62 Electric Wire
63 Terminal Body Portion
64 Positioning Protrusion
65 Connecting Portion
66 Pressure Receiving Portion
67 Elastic Contact Piece
68 Contact Portion
69 Guide Surface
70 Opening
71 Protrusion

1. A stacked connector comprising:
at least one first housing that has a flat shape; and
at least one second housing that has a flat shape and is stacked on the first housing,
wherein the first housing and the second housing have different shapes and are alternately stacked in a stacking direction,
the first housing has a first elastic locking piece that is elastically deformable and extends in a cantilever-like shape in a direction orthogonal to the stacking direction in which the first housing and the second housing are stacked, and a first locking portion that is not elastically deformable,
the second housing has a second elastic locking piece that is elastically deformable and extends in a cantilever-like shape in a direction that intersects the stacking direction, and a second locking portion that is not elastically deformable,
the first housing and the second housing are held in a stacked state by the first elastic locking piece and the second locking portion engaging with each other or the second elastic locking piece and the first locking portion engaging with each other,
the second locking portion is locked to the first elastic locking piece of the first housing stacked on one side in the stacking direction at a position on one side in a direction that intersects the stacking direction,
the second elastic locking piece is locked to the first locking portion of the first housing stacked on the other side in the stacking direction at a position on the other side in the direction that intersects the stacking direction,
the first locking portion is locked to the second elastic locking piece of the second housing stacked on one side in the stacking direction at a position on one side in a direction that intersects the stacking direction, and
the first elastic locking piece is locked to the second locking portion of the second housing stacked on the other side in the stacking direction at a position on the other side in the direction that intersects the stacking direction.

2. The stacked connector according to claim 1,
wherein the first elastic locking piece is disposed along an outer surface that is parallel to the stacking direction, of the first housing, and
the second elastic locking piece is disposed along an outer surface that is parallel to the stacking direction, of the second housing.

3. The stacked connector according to claim 1,
wherein a relative movement direction in which the first housing and the second housing move relative to each other when the first elastic locking piece engages with the second locking portion or when the second elastic locking piece engages with the first locking portion is parallel to a direction in which the first elastic locking piece and the second elastic locking piece extend.

4. The stacked connector according to claim 3,
wherein the first housing and the second housing are each provided with a guide portion that extends in a direction parallel to the relative movement direction of the first housing and the second housing.

5. The stacked connector according to claim 4,
wherein a guide length of each guide portion is shorter than a total length of the first housing or a total length of the second housing in a lengthwise direction of the guide portion.

6. The stacked connector according to claim 1,
wherein the first housing and the second housing are each provided with a terminal housing portion that houses a terminal fitting in such a manner that the terminal fitting is exposed in the stacking direction.
